(19) United States
(12) Patent Application Publication
(10) Pub. No.: US 2017/0148045 A1
(43) Pub. Date: May 25, 2017

(54) System and Method of Integrating In-Restaurant Food Ordering, Paying, and Reviewing with Online-to-Offline Platform

(71) Applicants: Myeongchul Shin, Irvine, CA (US); Juwan Yoo, Irvine, CA (US)

(72) Inventors: Myeongchul Shin, Irvine, CA (US); Juwan Yoo, Irvine, CA (US)

(21) Appl. No.: 14/946,422

(22) Filed: Nov. 19, 2015

(51) Int. Cl. G06Q 30/02; G06Q 50/12; G06Q 20/10

(52) U.S. Cl. CPC G06Q 30/0217; G06Q 30/0225; G06Q 30/0234; G06Q 20/102; G06Q 50/12

(57) ABSTRACT

The illustrated embodiments integrate in-restaurant food ordering, paying, and reviewing using online and offline communications. The system, using offline beacons, detects which specific table a user sits at in a restaurant. A user orders and pays for the food while the system tracks what dishes the user orders. The system is enabled simply by placing the user's phone on the table; the user need not open an application or interact with the phone. Even if the user doesn't order or pay using the phone, the system will automatically save dining history. This system requires no human involvement to map the customer to the point-of-sale system. A transaction based review feature and a health care and nutrition tracking feature is included. By tracking and storing data on food ordered and reviews generated by the user, the system performs dining curation by tracking user's dining patterns to suggest food and restaurants.

### BACKGROUND

Field of the Invention

The invention relates to the field of data processing systems of methods, specially adapted for commercial purposes. More specifically, it relates to the systems or methods specially adapted for a specific business sector, of services and restaurants. Namely, the fields of invention are CPC G06Q, 50/12, 20/237, 10/02, 20/20, 20/322.

The Problem

There is no efficient system for ordering, paying, and reviewing food using user equipment. Prior art used online communications to allow a user to order, pay, review, and suggest food from user equipment. However, these past systems did not allow the user to interact with the system without interacting with the equipment. Further, there are too many restaurant applications for smartphones, none of which integrate all components together in a convenient way that empowers the user. This invention, by using online and offline communications, allows the system to track the user history by simply placing the phone on the restaurant table. This invention is a system that would be a digital waiter (with ordering and payment capabilities) integrated into the restaurant's computer service and ordering system using off-line (LAN)/online Bluetooth connections. This application also uses internet presentation of customer responses, menus, and input access from customers. Furthermore, by using offline beacons, the system can detect which specific table a user sits at in a restaurant such that the system can track what dishes the user orders while the user orders and pays for the food. combination that integrates several restaurant-based functions. Even if the user doesn't order or pay using the phone, the system will automatically save dining history. This system requires no human involvement to map the customer to the point-of-sale system. Furthermore, a transaction based review feature and a health care and nutrition tracking feature is included. By tracking and storing data on food ordered and reviews generated by the user, the system performs dining curation by tracking user's dining patterns to suggest food and restaurants.

### BRIEF SUMMARY

This illustrated embodiments of the invention include three overall apparatus or processes: (1) an apparatus of transaction enabled review and credit back for additional detail; (2) Restaurant ordering and review system; and (3) Method of suggesting consumable items based on ingredient and/or caloric history of the user.

### BRIEF DESCRIPTION OF THE SEVERAL VIEWS OF THE DRAWINGS

To easily identify the discussion of any particular element or act, the most significant digit or digits in a reference number refer to the Figure number in which that element is first introduced.

FIG. 1 is a simplified block diagram showing one embodiment which illustrates a method 100 of allowing users to leave reviews of food or restaurants only when the user has actually purchased the dish or from the restaurant.

FIG. 2 is a simplified block diagram showing another embodiment which illustrates a method 200, which is the same as method 100 except that the transaction validation server and user review server are combined into one transaction enabled review server.

FIG. 3 is a simplified flowchart illustrating yet another embodiment which illustrates a method 300 of allowing users to leave reviews of food or restaurants only when the user has actually purchased the dish or from the restaurant.

FIG. 4 is a simplified block diagram showing one embodiment which illustrates a method 400 of using offline beacons to identify and couple a user to a specific table and to a specific restaurant.

FIG. 5 is a simplified block diagram illustrating another embodiment which illustrates a method 500, which is the same as method 400 except that the transaction validation server and user review server are combined into one transaction enabled review server.

FIG. 6 is a simplified flowchart illustrating yet another embodiment which illustrates a method 600 of using offline beacons to identify and couple a user to a specific table and to a specific restaurant.

FIG. 7 is a simplified block diagram showing an embodiment which illustrates a method 700 of using a computer medium to store and access food and health data of a user to suggest food at a particular restaurant the user it at with nutrition within the user's health restrictions.

FIG. 8 is a simplified block diagram illustrating another embodiment which illustrates a method 800, which is the same as method 700 except that the consumable item suggestion is derived not from an outside server, but by a consumable item suggestion module within the user equipment.

FIG. 9 is a simplified block diagram illustrating yet another embodiment which illustrates a method 900, which is the same as method 700 except that the user profile storage, food data storage, and dietary healthy data storage are stored within the user equipment.

FIG. 10 is a simplified flowchart illustrating an embodiment which illustrates a method 1000 of how the computer medium can store and access food and health data of a user to suggest food at a particular restaurant the user it at with nutrition within the user's health restrictions.

### DETAILED DESCRIPTION

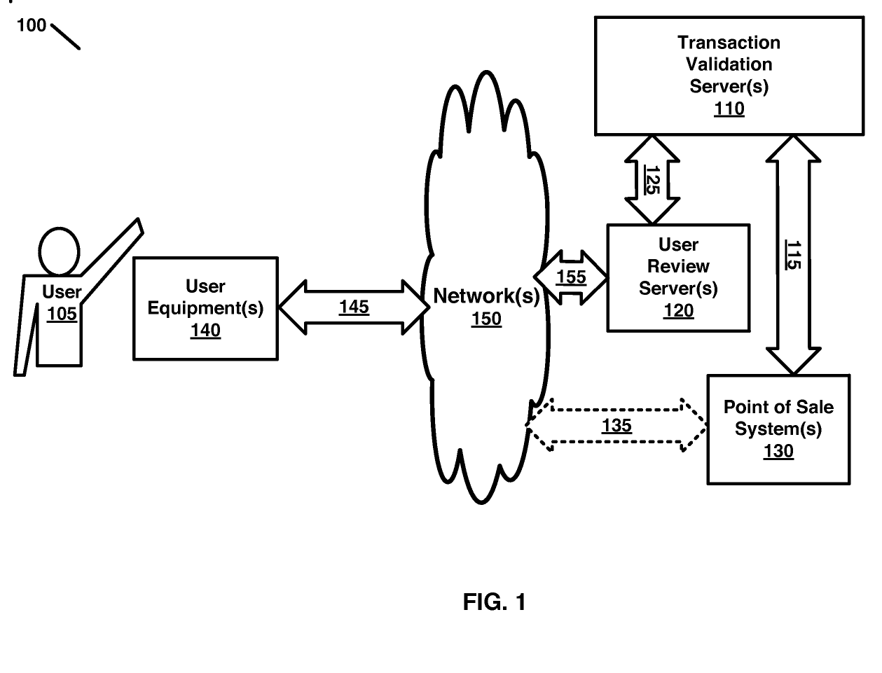

FIG. 1 is a block diagram which illustrates a method 100 of allowing users to leave reviews of food or restaurants only when the user has actually purchased the dish or from the restaurant. The user 105 utilizes the user equipment 140, such as a smartphone or a tablet to communicate with the network 150, such as a cellular network or the internet. The network 150 is communicated with the user review server 155 when the user wants to leave a review. However, the user 105 is first validated via communication step 125 with the transaction validation server 110, which ensures the user 105 actually ordered at the restaurant or bought the dish that the user wants to review. When the network 150 accesses the user review server 120, the review server 120 accesses the transaction validation server 110 to make sure the user 105 actually ordered from the restaurant or ordered the food or dish in question. This transaction validation server 110 also communicates with the point-of-sale system 130, such as the point-of-sale of the restaurant, in order to receive validation of user purchase via communication step 115. When the point of sale system 130 acknowledges a completed purchase by the user 105, then it communicates with the transaction validation server 110 via communication step 115 to tell the server 110 the user 105 did in fact make the order. In this way, the point of sale system 130 can communicate indirectly with the network through communication step 135 if the user 105 chooses the place orders with the live in-store employee, as denoted in FIG. 1 by using dotted lines for communication step 135. As an optional feature, the point-of-sale system 130 can also communicate directly with the network 150 if the user 105 chooses to order using the user equipment 140. Then, the transaction validation server 110 communicates with the user review server 120 via communication step 125 to tell the server that the user 105 is validated to leave a review. Then the user review server 120 communicates with the network 150 via communication step 155 to tell the network 150 to allow the user equipment 140 to access a review screen, to allow the user 105 to leave a review.

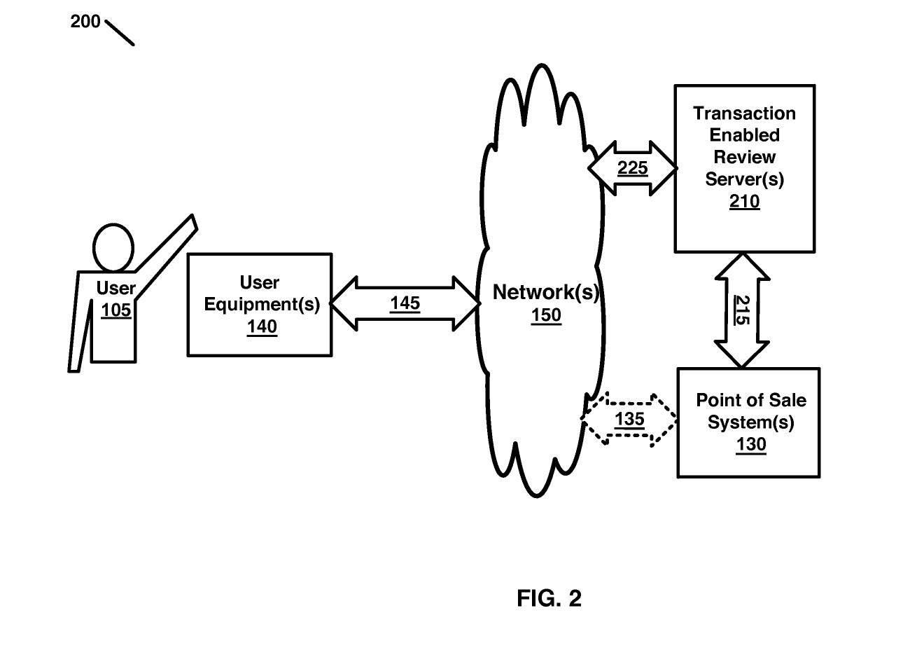

FIG. 2 is a block diagram illustrating another embodiment of the method 200 of validating users to allow users to leave reviews of food or of restaurants only when the user has actually purchased the dish or from the restaurant. FIG. 2 shows a different embodiment from FIG. 1 in that the user review server 120 and the transaction validation server 110 of FIG. 1's embodiment are combined in FIG. 2 to form a single transaction enabled review server 210, eliminating the communication step 125. The user 105 uses the user equipment 140, such as a smartphone or a tablet to communicate via communication step 145 with the network 150, such as a cellular network or the internet. The network 150 then communicates directly with the transaction enabled review server 210 via communication step 225 when the user 105 wants to leave a review. This server 210 can validate the transaction to ensure the user 105 actually ordered at the restaurant or bought the dish that the user 105 wants to review. This transaction enabled review server 210 can communicate with the point-of-sale system 130, such as the point-of-sale of the restaurant, in order to receive validation of user purchase via communication step 215. When the point of sale system 130 acknowledges a completed purchase by the user, then it communicates with the transaction enabled review server 210 via communication step 215 to tell the server 210 that the user 105 did in fact make the order. In this way, the point of sale system 130 can interact indirectly with the network at communication step 135, as denoted by using dotted lines for step 135. Then, the transaction enabled review server 210 communicates with the network 150 via communication step 225 to allow the user equipment 140 to access a review screen, to allow the user 105 to leave a review.

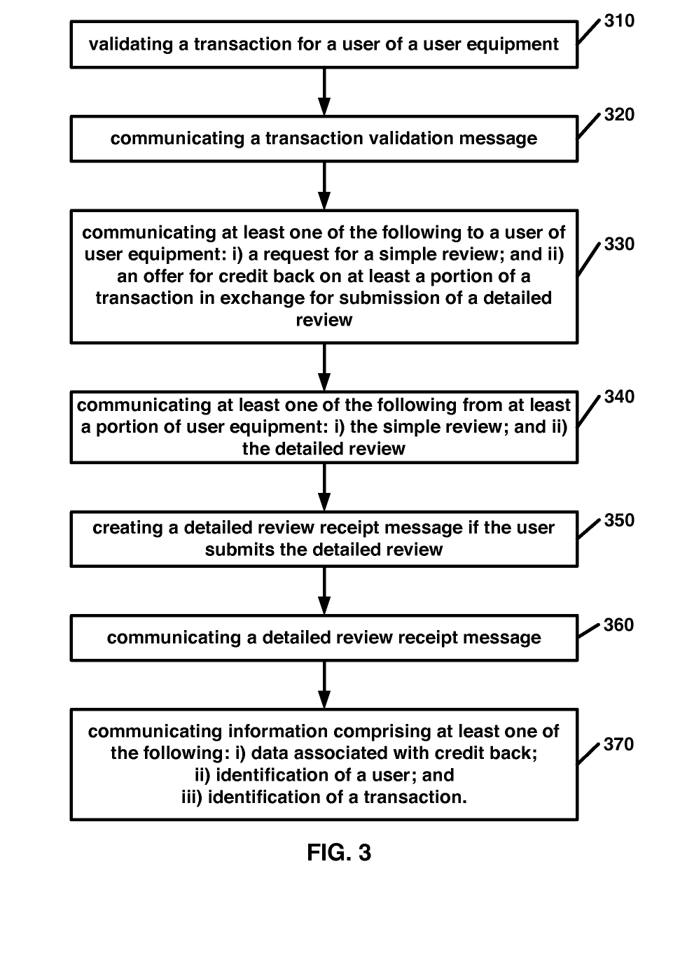

FIG. 3 is a flowchart which illustrates how the system of FIGS. 1 and 2 allows a user to leave a review only when validated. First, at step 310, a server 110, 210 validates a transaction for a user 105 of the user equipment 140. Then, at step 320, the server 120, 210 communicates a transaction validation message to the network 150. Next, at step 330, the user or transaction enabled review server 120, 210 communicates at least one of the following to a user 105 of user equipment 140: 1) a request for a simple review, and 2) an offer for credit back on at least a portion of the transaction in exchange for submission of a detailed review. Then, at step 340, the user or transaction enabled review server 120, 210 communicates a simple review or a detailed review to the user equipment 140. Then, at step 350, the user review or transaction enabled server 120, 210 creates a detailed review receipt message if the user 105 submits the detailed review. At step 360, the detailed review receipt message is sent to the user equipment 140. Then, at step 370, any of the following pieces of information are communicated to the user equipment 140 from the user or transaction enabled review server 120, 210: 1) the data associated with credit back, 2) identification of a user, and 3) identification of a transaction.

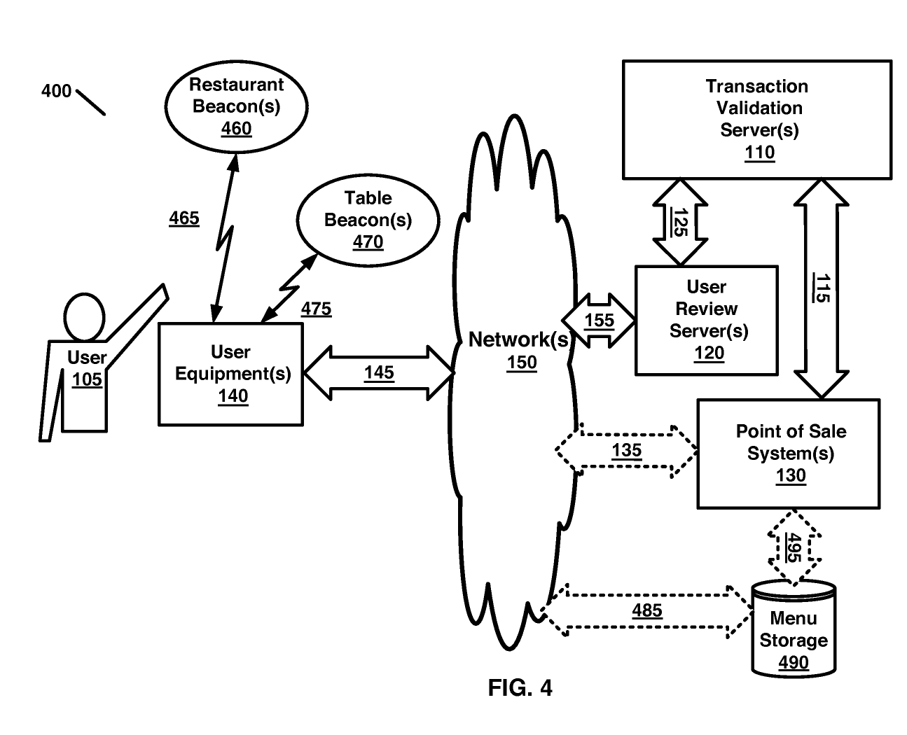

FIG. 4 is a block diagram which illustrates a system 400 of using beacons 460, 470 to identify and associate a user 105 to a specific table via communication step 475 and to a specific restaurant via communication step 465. The identification of the user 105 at a specific table at a specific restaurant allows the user equipment 140, without further action by the user 105 other than having the user equipment 140 on the table, to track the orders made by the user 105 in an offline setting.

The offline restaurant beacon 460 includes a general beacon, such as a Bluetooth enabled beacon. Each restaurant has its own restaurant beacon 460, which sends out a unique, encrypted identifier that is received and decrypted by the user equipment 140, such that the user equipment 140 can identify in which restaurant that user 105 is sitting via communication step 465 to the user equipment 140.

The offline table beacon 470 includes a general beacon, such as a Bluetooth enabled beacon. Each table at a restaurant has its own table beacon 470, which sends the information of which table the user 105 is sitting at via communication step 475, through a unique, encrypted identifier that is received and decrypted by the user equipment 140, such that the user equipment 140 can identify at which table that user 105 is sitting.

Then, the user equipment 140 communicates online with the network 150, such as a cellular network or the internet to directly communicate with the user review server 120 when the user 105 wants to leave a review. However, the user 105 is first validated via communication step 125 by the transaction validation server 110, which ensures the user 105 has actually ordered at the restaurant or bought the dish that the user 105 wants to review. When the network 150 is trying to access the user review server 120, the review server 120 accesses the transaction validation server 110 to make sure the user 105 actually ordered from the restaurant or ordered the dish in question. This transaction validation server 110 can also communicate with the point-of-sale system 130, such as the point-of-sale system of the restaurant, in order to receive validation of user purchase via communication step 115. When the point-of-sale system 130 acknowledges a completed purchase by the user 105, it then communicates with the transaction validation server 110 via communication step 115 to tell the server 110 the user 105 did in fact order the dish. In this way, the point of sale system 130 can communicate indirectly with the network at communication step 135 if the user chooses to place orders with the live in-store employee, as denoted by the use of dotted lines. As an optional feature, the point-of-sale system 130 can also communicate directly with the network 150 if the user 105 chooses to order using the user equipment 140. If the user 105 elects to use the optional feature to communicate directly with the network 150 by ordering using the user equipment 140, then a menu storage server 490 will interact with the network 150 via communication step 485 to allow the user 105 to access the menu information. This menu storage server 490 then communicates with the point of sale system 130 to allow the user 105 to also pay using his or her user equipment 140.

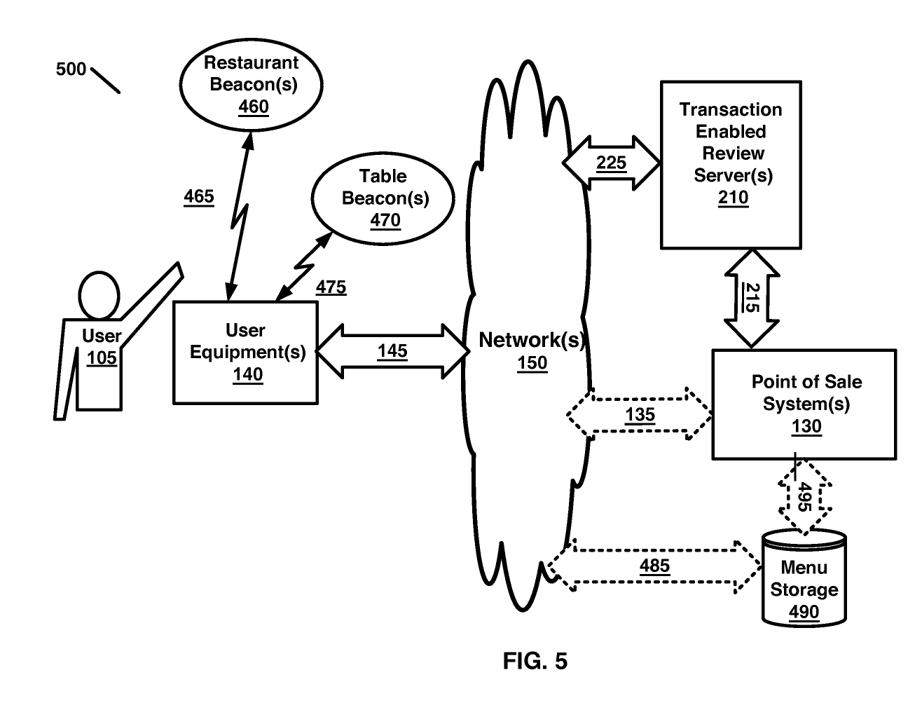

FIG. 5 is a block diagram which illustrates a similar embodiment to that in FIG. 4, where the difference is that the transaction validation server 110 and the user review server 120 are combined into the transaction enabled review server 210.

FIG. 5 shows the system 500 of using beacons 460, 470 to identify and associate a user 105 to a specific table via communication step 475 and to a specific restaurant via communication step 465. The identification of the user 105 as a specific table at a specific restaurant allows the user equipment 140, without further action by the user 105 other than having the user equipment 140 on the table, to track the orders made by the user 105 in an offline setting.

The offline restaurant beacon 460 includes a general beacon, such as a Bluetooth enabled beacon. Each restaurant has its own restaurant beacon 460, which sends out a unique, encrypted identifier that is received and decrypted by the user equipment 140, such that the user equipment 140 can identify in which restaurant that user 105 is sitting via communication step 465 to the user equipment 140.

The offline table beacon 470 includes a general beacon, such as a Bluetooth enabled beacon. Each table at a restaurant has its own table beacon 470, which sends the information through a unique, encrypted identifier that is received and decrypted by the user equipment 140, such that the user equipment 140 can identify at which table that user 105 is sitting,

Then, the user equipment 140 communicates online with the network 150, such as a cellular network or the internet to communicate directly with the transaction enabled review server 210 when the user 105 wants to leave a review, to ensure the user 105 actually ordered at the restaurant or bought the dish that the user 105 wants to review. This transaction enabled review server 210 can also communicate with the point-of-sale system 130, such as the point-of-sale system of the restaurant, in order to receive validation of user purchase via communication step 215. When the point-of-sale system 130 acknowledges a completed purchase by the user 105, it then communicates with the transaction validation server 210 via communication step 215 to tell the server 210 that the user 105 did in fact order the dish in question. In this way, the point of sale system 130 can communicate indirectly with the network 150 at communication step 135 if the user 105 chooses to place orders with the live in-store employee, as denoted by the use of dotted lines for communication step 485. As an optional feature, the point-of-sale system 130 can also communicate directly with the network 150 if the user 105 chooses to order using the user equipment 140. If the user 105 elects to use the optional feature to communicate directly with the network 150 by ordering using the user equipment 140, then a menu storage server 490 will interact with the network 150 via communication step 485 to allow the user access to the menu information. This menu storage server 490 can then communicate with the point of sale system 130 to allow the user to also pay using his or her user equipment 140.

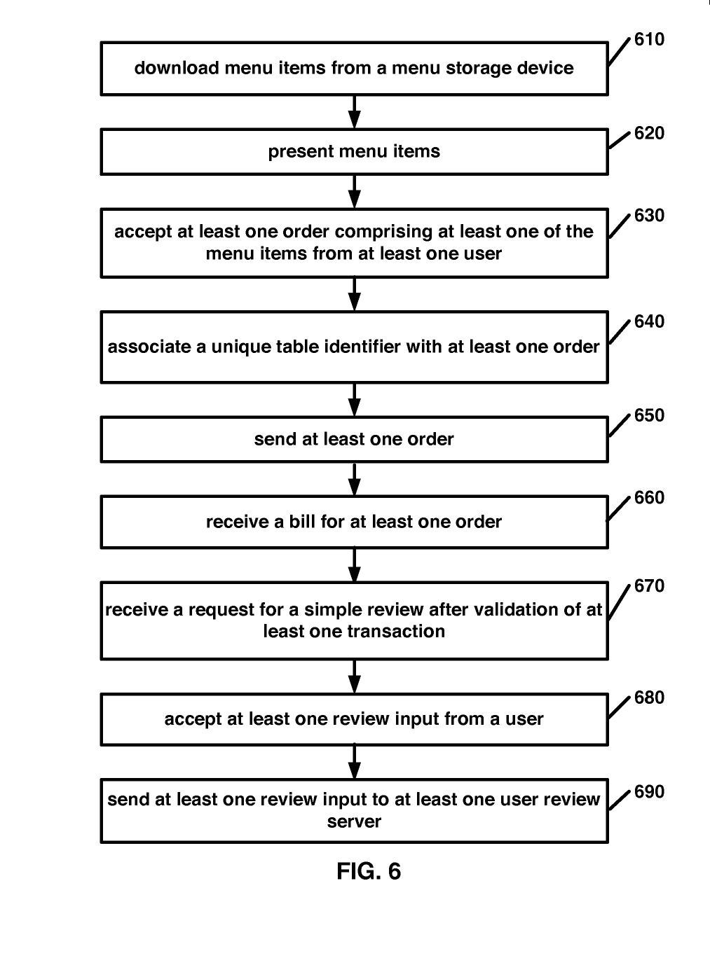

FIG. 6 is a flowchart which illustrates how the offline beacon systems of FIGS. 4 and 5 associate a unique table identifier with at least one order, allow the user equipment to not only store data on orders but also allow the user 105 to order and pay from the user equipment 140. First, at step 610, the user equipment 140 communicates with the network 150 to download menu items from a menu storage device 490. Then, at step 620, the user equipment 140 presents the menu items to the user 105 on the user equipment 140. Next, at step 630, the user equipment 140 accepts at least one order compromising at least one of the menu items from at least one user 105. Then, at step 640, the offline beacons 470 associate a unique table identifier with at least one order. Then, at step 650, the user equipment 140 communicates with the network 150 to send at least one order to the point-of-sale system 130. At step 660, the user equipment 140 receives a bill for at least one order from the point-of-sale system 130. Then, at step 670, the user equipment 140 receives a request for a simple review from the user or transaction enabled review server 120, 210 after validation of at least one transaction. Then, at step 680, the user equipment 140, accepts at least one review input from the user 105. At step 690, the user equipment 140 communicates with the network 150 to send at least one review input to at least one user or transaction enabled review server 120, 210 using network 150.

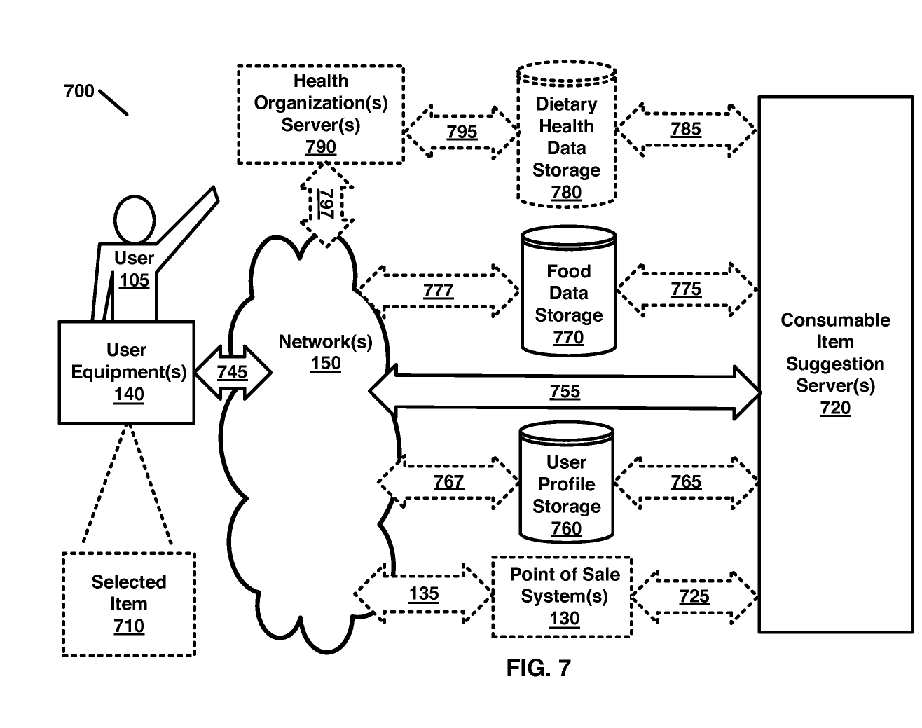

FIG. 7 is a block diagram of one embodiment illustrating how a computer stores and accesses food and health data of a user 105 to suggest food at a particular restaurant where the user 105 is with suggestions compliant with the user's health restrictions.

First, the user 105 inputs commands to the user equipment 140. One option is for the user 105 to select a food item from a restaurant's menu 710. Then, after selecting this item 710, the user equipment 140 communicates the selection to the network 150 via communication step 145 to order the selected item 710 using point of sale software 130 via communication step 135;store the selected item 710 as a part of the user's profile on the user profile storage server 760 via communication step 767; store the selected item on the food data storage server 770 via communication step 777; send the selected item's nutritional information to a health organization server 790 via communication step 797 to either become part of the medical record of the user 105 or part of an overall nutrition information collection for disease prevention.

Alternatively, the user 105 could use the user equipment 140 to communicate with a consumable item suggestion server 720 using the network via communication steps 145 and 755. The consumable item suggestion server 720 processes the request and suggests a food item back to the user 105 after choosing the item using an algorithm that weighs one of more of the following: the dietary health data storage 780 of the user 105, the food data history of the user 770, and/or the user profile 765. This consumable item suggestions server 720 can also communicate with the point-of-sale system 130 via communication step 725 to allow the user 105 to pay for the suggested item using the user equipment 140.

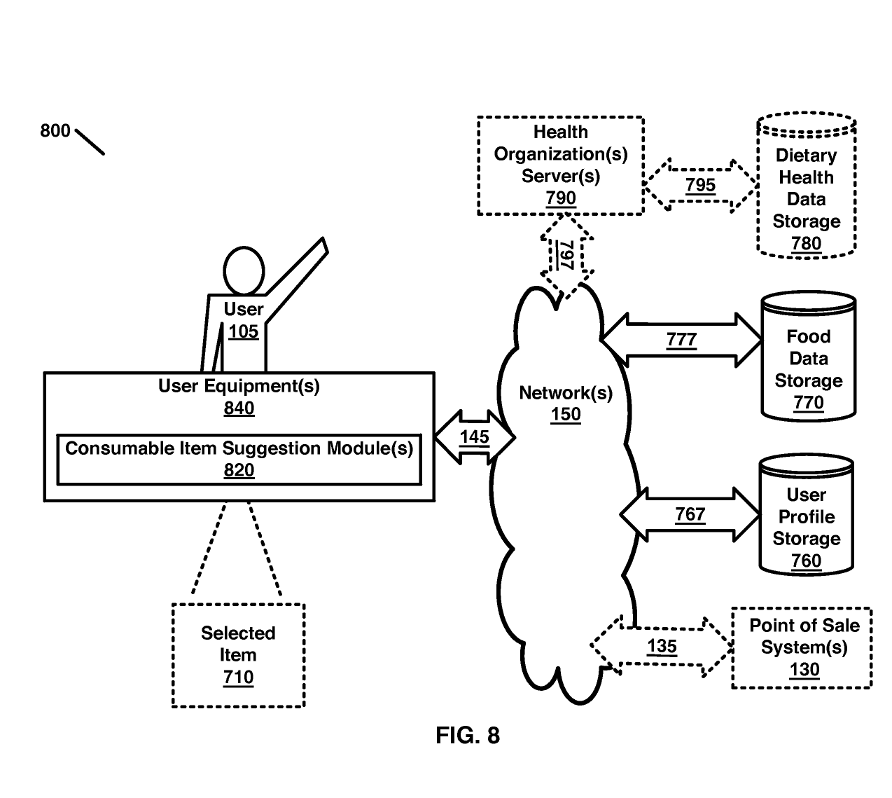

FIG. 8 shows a similar embodiment to that of FIG. 7, where the difference is that the consumable item suggestion is derived not from an outside server 720, but by a consumable item suggestion module 820 within the user equipment 840.

FIG. 8 is a block diagram of an embodiment illustrating how a computer stores and accesses food and health data of a user 105 to suggest food at a particular restaurant where the user 105 is with menu selections compliant with the user's health restrictions.

First, the user 105 communicates with the user equipment 840. One option is that the user 105 uses the user equipment 840 to select a food item from a restaurant's menu 710. Then, after selecting this item 710, the user equipment 840 communicates with the network 150 via communication step 145 to: order the selected item 710 using point of sale software 830 via communication step 835; store the selected item 710 as a part of the user's profile on the user profile storage server 760 via communication step 767; store the selected item on the food data storage server 770 via communication step 777; send the selected item's nutritional information to a health organization server 790 via communication step 797 to either become part of the dietary health data storage 780 of the user 105, or part of an overall nutrition information collection for disease prevention.

Alternatively, the user 105 uses the user equipment 840, which includes the consumable item suggestion module 820 in the form of an application stored within the user equipment 840. The consumable item suggestion module 820 processes the request and suggests a food item back to the user 105 after choosing the item 710 using an algorithm that weighs one of more of the following: the dietary health data storage 780 of the user, the food data history of the user 770, and/or the user profile 865. This consumable item suggestions module 820 may also communicate with the point-of-sale system 830 via communication step 825 to allow the user 105 to pay for the suggested item 710 using the user equipment 840.

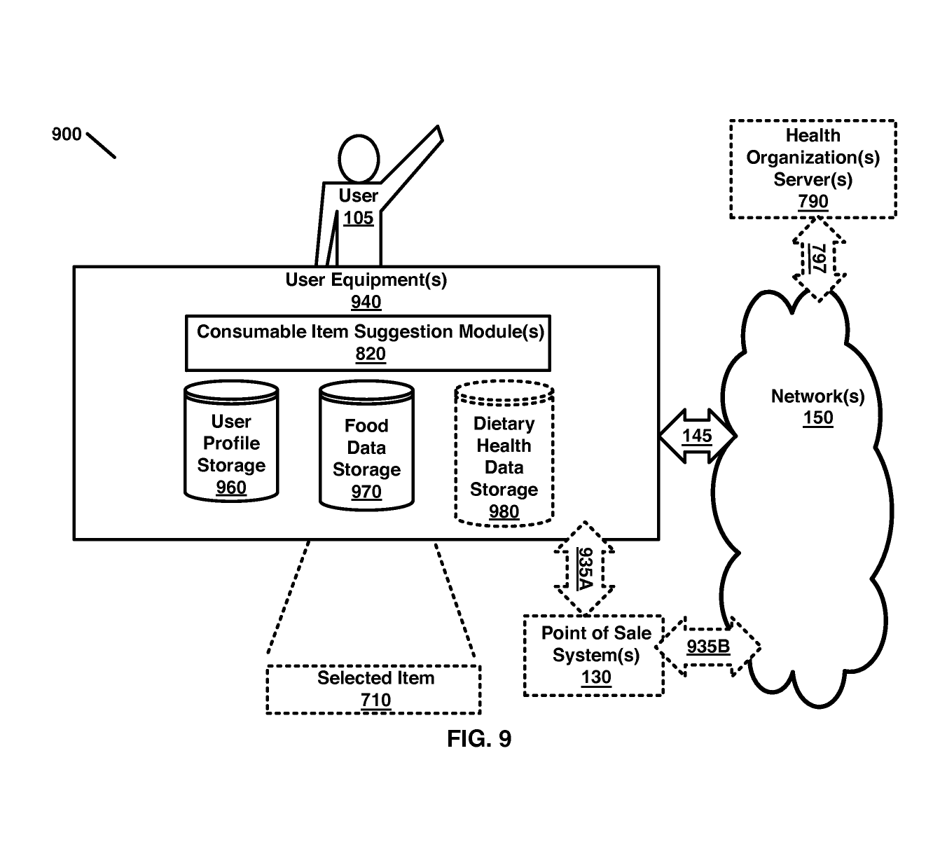

FIG. 9 is a block diagram which illustrates a similar embodiment to FIG. 7 and FIG. 8, where the difference is that the consumable item suggestion module 820 is located within the user equipment 940 along with the user profile storage 960, the food data storage 970, and the dietary health data storage 980.

FIG. 9 illustrates how a computer stores and accesses food and health data of a user 105 to suggest food at a particular restaurant where the user 105 is with nutrition compliant with the user's health restrictions.

First, the user 105 communicates with the user equipment 940. One option is that the user 105 uses the user equipment 940 to select a food item from a restaurant's menu 710. This selected item 710 is ordered by the user equipment 940 by directly communicating with the point of sale system 130 via communication step 935A. The selected item 710 is then stored on the user equipment 940 as a part of the user's profile on the user profile storage server 960, or on the food data storage server 970, or as part of the dietary health data storage 980 of the user 105.

Alternatively, after selecting an item, the user equipment 940 communicates with the network 150 via communication step 145 to order the selected item 710 using point of sale system 130 via communication step 935B, or sends the selected item's nutritional information to a health organization server 790 via communication step 797 to become part of the user's medical record, or part an overall nutrition information collection for disease prevention.

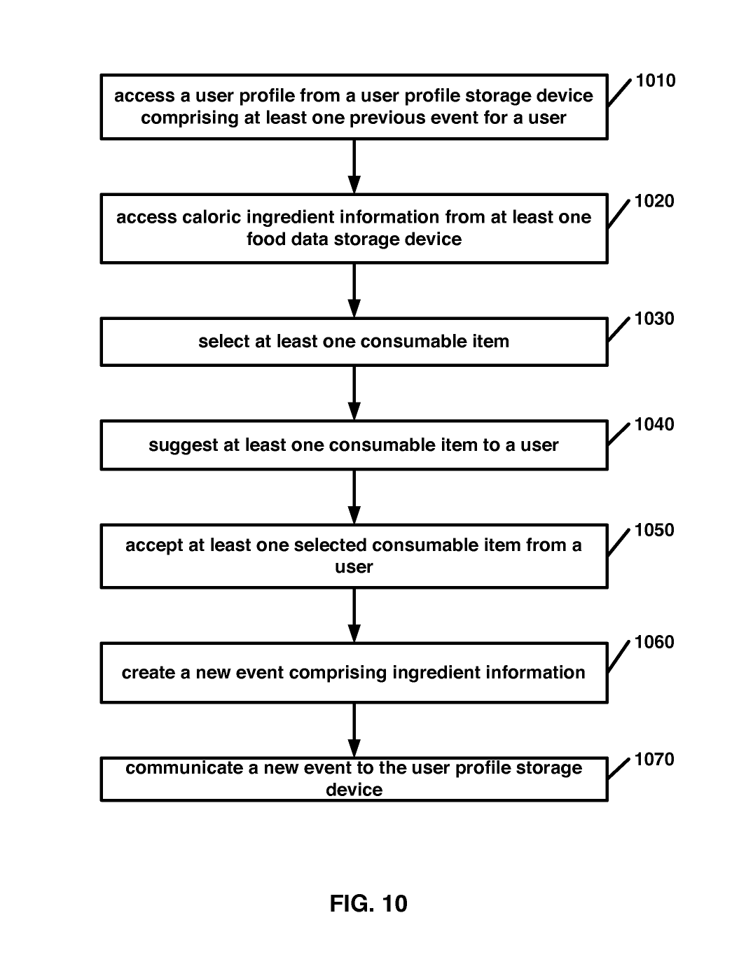

FIG. 10 is a flowchart which illustrates how a computer stores and accesses food and health data of a user 105 to suggest food at a particular restaurant where the user 105 is with nutrition compliant with the user's health restrictions.

First, at step 1010, the user equipment 140, 840, 940 accesses a user profile from a user profile storage device either a separate server 720 as depicted in FIG. 7 or as a part or the user equipment 840, 940 as depicted in FIGS. 8 and 9, comprising at least one previous event for the user 105. Then, at step 1020, the user equipment 140, 840, 940 accesses caloric ingredient information from at least one food data storage device 770, 970. At step 1030, user 105 selects at least one consumable item. Alternatively, at step 1040, a consumable item suggestion algorithm either a separate server 720 as depicted in FIG. 7 or as a component of the user equipment 840, 940 as depicted in FIGS. 8 and 9 suggests at least one consumable item to user 105. Then, at step 1050, the user equipment 140, 840, 940 accepts at least one selected consumable item from user 105. At step 1060, the user equipment 140, 840, 940 creates a new event comprising ingredient information of the selected item. Then, at step 1070, the user equipment 140, 840, 940 communicates the new event to the user profile storage device 760, 960.

What is claimed is:

1. A system in combination with user equipment used by a user of a food services establishment comprising:
a point of sale system;
a user review server communicated with the user equipment;
a transaction validation server communicated with the user review server and point of sale system, the transaction validation server to validate a transaction for the user of the user equipment, the transaction being conducted between the user and the point of sale system associated with the food services establishment, wherein the transaction is communicated to the user review server and the transaction validation server;
where the user review server receives a transaction validation message from the transaction validation server, the review server sending at least one of the following to the user of the user equipment:
a request for a simple review of the food services establishment; and
an offer for a credit back on at least a portion of the transaction in exchange for submission of a detailed review comprising at least one experience associated with the food services establishment; and
wherein the user equipment sends at least one of the following to the user review server:
a simple review; and
a detailed review;
where the user review server is configured to communicate a detailed review receipt message to the transaction validation server if the user submits the detailed review; and
the transaction validation server is configured to communicate information to the point-of-sale system upon receipt of the detailed review receipt message, either immediately or on the same business day, the information comprising at least one of the following:
data associated with the credit back;
identification of the user; and
identification of the transaction.

2. The system of claim 1, where the user review server and transaction validation server are combined within a single transaction enabled review server.

3. The system of claim 1, wherein the user review server matches the user with a transaction through the user equipment employing either the transaction validation server communicating with the point-of-sale system or directly through the user equipment to the point-of-sale system.

4. The system of claim 3, where the user review server and transaction validation server are combined within a single transaction enabled review server.

5. The system of claim 1, wherein the user equipment presents the user with a selectable choice associated with a request for the simple review, and a request for at least one of the following:
an overall rating of the food services establishment; and
an overall rating of at least one menu item.

6. The system of claim 1, wherein the simple review and the detailed review is accessible on the user review server through the network.

7. The system of claim 1, wherein the experience comprises at least one of the following:
location value;
ease of parking;
bicycle parking;
time waiting in line;
time waiting to be seated;
host friendliness;
server friendliness;
handicap accessible;
kid friendly;
group friendly;
variety of menu;
ordering process;
accepts substitutions in menu items;
price of menu item;
vegan friendly;
offers gluten-free options;
taste of menu item;
freshness of menu item;
quality of menu item;
value of menu item;
ambience;
noise level;
music;
décor; and
cleanliness of facility.

8. An ordering and review system of a restaurant for a plurality of restaurant patrons comprising:
a menu storage device;
a point of sale system;
a user review server;
a transaction validation server
a plurality of restaurant location beacons, each broadcasting participation by the restaurant in the ordering and review system;
a plurality of table specific location beacons, each configured to broadcast a unique table identifier within the restaurant; and
a plurality of units of user equipment, where each restaurant patron uses more than unit of user equipment or many users share one unit of user equipment, each of which units of user equipment:
downloads a menu item from the menu storage device;
presents the downloaded menu items;
accepts at least one order comprising at least one of the menu item from at least one restaurant patron;
associates a unique table identifier with the at least one order;
sends at least one order to the point-of-sale system associated with the restaurant, where the order is communicated through the user review server, and transaction validation server;
receives a bill for the at least one order;
receives a request for a simple review from the user review server, where the user review server receives a transaction validation from the transaction validation server, with the transaction validation server in communication with the point of sale system to validate a payment with transaction validation required prior to generating a simple review request, and where a payment is sent to the point-of-sale system, where the payment is communicated through the user review server, transaction validation server;
accepts a review from the restaurant patron; and
sends the review to the user review server.

9. The ordering and review system of claim 8, wherein the user review server and transaction validation server are combined into a single transaction enabled review server.

10. The ordering and review system of claim 8 in further combination with a plurality of restaurants, wherein the menu storage server accepts menu items from the plurality of restaurants, where the menu storage server is combined with the user review server or the transaction validation server.

11. The ordering and review system of claim 8 in further combination with a plurality of restaurants, wherein the menu storage server accepts menu items from the plurality of restaurants, where the menu storage server is combined with the transaction enabled review server.

12. The ordering and review system of claim 8, wherein the user equipment:
links an order with a user identifier associated with the restaurant patron; and
sends a menu item associated with the order to the user review server.

13. The ordering and review system according to claim 8, wherein the user equipment downloads a history of at least one menu item previously ordered by the user.

14. The ordering and review system of claim 8, wherein the user review server presents the simple review for viewing by a plurality of users

15. The ordering and review system according to claim 8 wherein the user equipment presents a request for the simple review comprising a selectable choice comprising at least one of the following:
an overall rating of the restaurant; and
an overall rating of the menu items.

16. A tangible non-transitory computer readable medium comprising instructions causing one or more processors, in combination with a consumable item suggestion server and/or unit of user equipment, to:
access a user profile from a user profile storage device, the user profile associated with at least one previous event for a user, at least one previous event comprising data describing at least one consumed ingredient;
access ingredient information from at least one food data storage device, the food data storage device comprising data for a plurality of consumable items, where the consumable items includes menu items, grocery items, or packaged foods;
select at least one consumable item from the plurality of consumable items, the selection being based at least in part on the at least one previous event with an algorithm designed to determine which ingredients cause negative consequences based on previous events;
suggest at least one consumable item to the user via the user equipment;
accept at least one selected consumable item from the user via the user equipment;
create a new event comprising ingredient information for at least one selected consumable item; and
communicate the new event to the user profile storage device.

17. The non-transitory computer readable medium of claim 16, wherein the instructions further causing the one or more processors to select at least one consumable item based, at least in part, on at least one of the following:
a caloric preference;
an ingredient preference, where a preference may comprise preferred food or food to avoid;
a dietary need, such as instructions from a health practitioner;
a caloric reaction input; and
an ingredient reaction input.

18. The non-transitory computer readable medium of claim 16, wherein the instructions further causing one or more processors to access dietary health information from at least one dietary health data storage server, which can correlate ingredient information with symptom and/or disease resolution.

19. The non-transitory computer readable medium of claim 16, wherein the instructions further causing one or more processors to suggest a selection of at least a portion of consumable items presented on a menu, the selection comprising at least one consumable item.

20. The non-transitory computer readable medium of claim 16, wherein the instructions further causing one or more processors to communicate at least a portion of at least one of the following to at least one health organization:
a previous event;
ingredient information;
a new event;
a caloric preference;
an ingredient preference;
a dietary need;
a caloric reaction input; and
an ingredient reaction input.
